(19) United States
(12) Patent Application Publication
(10) Pub. No.: US 2018/0098333 A1
(43) Pub. Date: Apr. 5, 2018

(54) SCHEDULING CARRIER AGGREGATION (CA)-CAPABLE AND NON-CA-CAPABLE USER EQUIPMENTS (UES) USING A RESOURCE BIAS PARAMETER

(71) Applicant: QUALCOMM Incorporated, San Diego, CA (US)

(72) Inventors: Raja Sekhar BACHU, Bridgewater, NJ (US); Chakrapani ARAVIND SURAPURA, Bridgewater, NJ (US); Jianghong LUO, Skillman, NJ (US)

(21) Appl. No.: 15/716,406

(22) Filed: Sep. 26, 2017

Related U.S. Application Data
(60) Provisional application No. 62/402,268, filed on Sep. 30, 2016.

(51) Int. Cl. H04W 72/12; H04W 24/08; H04W 72/02

(52) U.S. Cl. CPC H04W 72/12; H04W 88/02; H04W 72/02; H04W 24/08

(57) ABSTRACT

Aspects of the present disclosure provide methods and apparatus for scheduling UEs in a wireless cell. The method generally includes determining one or more characteristics of communications on a first cell for a first type of user equipments (UEs) and a second type of UEs. A cell determines a first set of resources for the first type of UEs and a second set of resources for the second type of UEs based, at least in part, on the determined one or more characteristics and a resource bias parameter. The cell assigns the first set of resources for communications between the first cell and the first type of UEs and the second set of resources for communications between the first cell and the second type of UEs.

### CROSS-REFERENCE TO RELATED APPLICATIONS

This application claims benefit of U.S. Provisional Patent Application Ser. No. 62/402,268, filed Sep. 30, 2016, entitled “Scheduling Carrier Aggregation (CA)-Capable and Non-CA-Capable User Equipments (UEs) Using a Resource Bias Parameter,” and assigned to the assignee hereof, the contents of which are hereby incorporated by reference in its entirety.

### BACKGROUND

### Technical Field

The present disclosure generally relates to resource scheduling for user equipments (UEs) in a cell, and more specifically to using a resource bias parameter to schedule resources for different types of UEs (e.g., carrier aggregation (CA)-capable and non-CA-capable UEs) connected to a cell.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Some wireless systems support connections and communications between a cell and different types of user equipment (UEs). For example, a cell may support communications with UEs that support carrier aggregation (CA) in which such UEs communicate with the cell using multiple carriers, and UEs that do not support CA (e.g., UEs that communicate with a cell using a single carrier. Such cells allocate resources to both CA-capable UEs and non-CA-capable UEs. Accordingly, it may be desirable to have a framework for determining resources to be used for communications with the CA-capable and non-CA-capable UEs.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide a method for scheduling user equipments (UEs) in a wireless cell. The method generally includes determining one or more characteristics of communications on a first cell for a first type of UEs and a second type of UEs. A cell determines a first set of resources for the first type of UEs and a second set of resources for the second type of UEs based, at least in part, on the determined one or more characteristics and a resource bias parameter. The cell assigns the first set of resources for communications between the first cell and the first type of UEs and the second set of resources for communications between the first cell and the second type of UEs.

Certain aspects of the present disclosure provide a system for scheduling user equipments (UEs) in a wireless cell. The system generally includes a processor and a memory coupled to the processor. The processor is generally configured to determine one or more characteristics of communications on a first cell for a first type of UEs and a second type of UEs, determine a first set of resources for the first type of UEs and a second set of resources for the second type of UEs based, at least in part, on the determined one or more characteristics and a resource bias parameter, and assign the first set of resources for communications between the first cell and the first type of UEs and the second set of resources for communications between the first cell and the second type of UEs.

Certain aspects of the present disclosure provide an apparatus for scheduling user equipments (UEs) in a wireless cell. The apparatus generally includes means for determining one or more characteristics of communications on a first cell for a first type of UEs and a second type of UEs, means for determining a first set of resources for the first type of UEs and a second set of resources for the second type of UEs based, at least in part, on the determined one or more characteristics and a resource bias parameter, and means for assigning the first set of resources for communications between the first cell and the first type of UEs and the second set of resources for communications between the first cell and the second type of UEs.

Certain aspects of the present disclosure provide a computer-readable medium for scheduling user equipments (UEs) in a wireless cell. The computer-readable medium has instructions stored thereon which, when executed, causes a processor to determine one or more characteristics of communications on a first cell for a first type of user equipments (UEs) and a second type of UEs, determine a first set of resources for the first type of UEs and a second set of resources for the second type of UEs based, at least in part, on the determined one or more characteristics and a resource bias parameter, and assign the first set of resources for communications between the first cell and the first type of UEs and the second set of resources for communications between the first cell and the second type of UEs.

Aspects generally include methods, apparatus, systems, computer program products, and processing systems, as substantially described herein with reference to and as illustrated by the accompanying drawings.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. The appended drawings illustrate only certain typical aspects of this disclosure, however, and are therefore not to be considered limiting of its scope, for the description may admit to other equally effective aspects.

FIG. 1 illustrates an exemplary deployment in which multiple wireless networks have overlapping coverage, in accordance with certain aspects of the disclosure.

FIG. 2 is a diagram illustrating an example of an access network, in accordance with certain aspects of the disclosure.

FIG. 3 is a diagram illustrating an example of a DL frame structure in LTE, in accordance with certain aspects of the disclosure.

FIG. 4 is a diagram illustrating an example of an UL frame structure in LTE, in accordance with certain aspects of the disclosure.

FIG. 5 is a diagram illustrating an example of a radio protocol architecture for the user and control plane, in accordance with certain aspects of the disclosure.

FIG. 6 is a diagram illustrating an example of an evolved Node B (eNB) and user equipment (UE) in an access network, in accordance with certain aspects of the disclosure.

FIG. 7 illustrates example operations that may be performed by a wireless cell to allocate resources for communications between different types of UEs based, at least in part, on a resource bias parameter, in accordance with certain aspects of the present disclosure.

FIG. 8 illustrates an example proportional fairness computation for allocating resources in different cells based, at least in part, on a resource bias parameter, in accordance with certain aspects of the present disclosure.

FIG. 9 is a flow chart illustrating example operations that may be performed by a cell for allocating resources to different types of UEs (e.g., carrier aggregation (CA)-capable and non-CA-capable UEs) based, at least in part, on a resource bias parameter, in accordance with certain aspects of the present disclosure.

FIGS. 10A and 10B illustrate example resource allocations determined based, at least in part, on a resource bias parameter, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide for allocating resources to different types of UEs (e.g., carrier aggregation (CA)-capable and non-CA-capable UEs) using a resource bias factor. The resource bias factor, which may be defined by a network operator, may allow a network operator to fairly allocate resources to CA-capable and non-CA-capable UEs.

Advantageously, allocating resources to different types of UEs using a resource bias factor may allow a cell to allocate resources to both CA-capable and non-CA-capable UEs such that resources are fairly allocated between CA-capable and non-CA-capable UEs. The resource bias factor used in allocating resources to different types of UEs may result, for example, in a resource allocation that allows CA-capable UEs to benefit from increased data rates and resource availability relative to non-CA-capable UEs while allocating sufficient resources for non-CA-capable UEs to communicate with the cell.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software/firmware, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software/firmware, or combinations thereof. If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

The techniques described herein may be used for various wireless communication networks such as code division multiple access (CDMA), time division multiple access (TDMA), frequency division multiple access (FDMA), orthogonal FDMA (OFDMA), single carrier FDMA (SC-FDMA) and other networks. The terms “network” and “system″” are often used interchangeably. A CDMA network may implement a radio access technology (RAT) such as universal terrestrial radio access (UTRA), cdma2000, etc. UTRA includes wideband CDMA (WCDMA) and other variants of CDMA. cdma2000 covers IS-2000, IS-95 and IS-856 standards. IS-2000 is also referred to as 1× radio transmission technology (1×RTT), CDMA2000 1×, etc. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), IEEE 802.11 (Wi-Fi), IEEE 802.16 (WiMAX), IEEE 802.20, Flash-OFDM®, etc. UTRA and E-UTRA are part of universal mobile telecommunication system (UMTS). 3GPP long-term evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and RATs mentioned above as well as other wireless networks and RATs.

It is noted that while aspects may be described herein using terminology commonly associated with 3G and/or 4G wireless technologies, aspects of the present disclosure can be applied in other generation-based communication systems, such as 5G and later.

### An Example Wireless Communication System

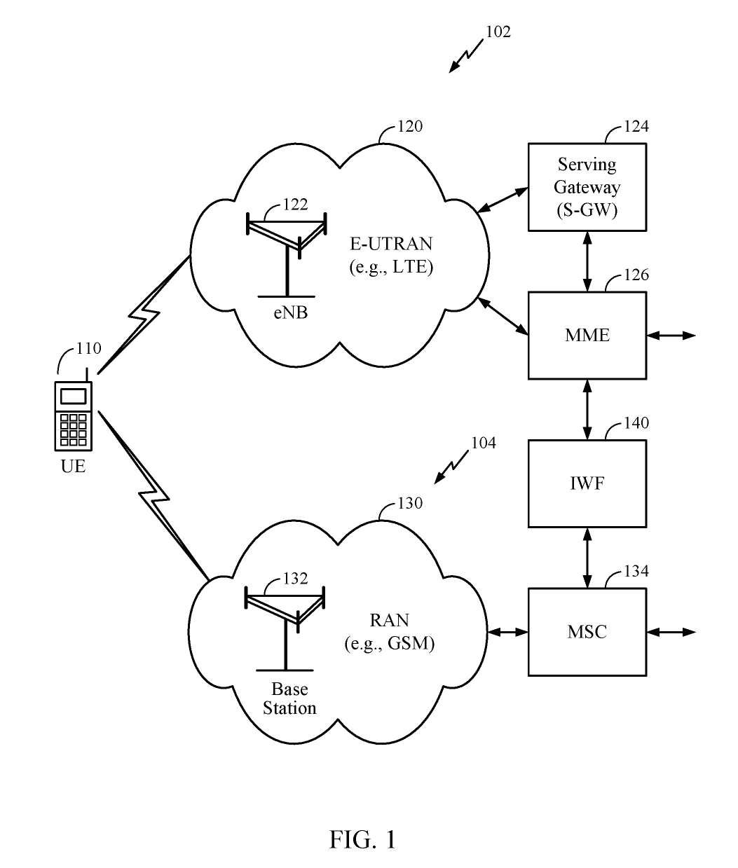

FIG. 1 illustrates an example deployment in which aspects of the present disclosure may be implemented. For example, a user equipment (UE) 110 transmits an uplink reference signal to a base station (BS) such as eNB 122 (e.g., a transmission reception point (TRP)). The uplink reference signal can include an indication of a preferred downlink beam. The UE 110 can receive a downlink from the eNB 122 based, at least in part, on the uplink reference signal. For downlink-based mobility, the UE may receive measurement reference signals (MRS) transmitted with different beams from the eNB 122. The UE 110 can select the preferred beam based on the MRS. The eNB 122 can beamform the downlink signal to the UE using the preferred beam and/or the eNB 122 can send a handover command to the UE 110 based, at least in part, on the uplink reference signal. For uplink-based mobility the UE 110 sends the uplink reference signal, without MRS from the eNB 122, and the eNB 122 can perform beam selection and/or handover decisions based on measurement of the uplink reference signal. In some cases, a non-serving eNB can receive the uplink reference signals and send a handover command to the UE 110.

FIG. 1 shows an exemplary deployment in which multiple wireless networks have overlapping coverage. A radio access network such as an evolved universal terrestrial radio access network (E-UTRAN) 120 may support LTE and may include a number of evolved Node Bs (eNBs) 122 (e.g., TRPs) and other network entities that can support wireless communication for user equipments (UEs). Each eNB may provide communication coverage for a particular geographic area. The term “cell” can refer to a coverage area of an eNB and/or an eNB subsystem serving this coverage area. A serving gateway (S-GW) 124 may communicate with E-UTRAN 120 and may perform various functions such as packet routing and forwarding, mobility anchoring, packet buffering, initiation of network-triggered services, etc. A mobility management entity (MME) 126 may communicate with E-UTRAN 120 and serving gateway 124 and may perform various functions such as mobility management, bearer management, distribution of paging messages, security control, authentication, gateway selection, etc. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

A radio access network (RAN) 130 may support GSM and may include a number of base stations 132 and other network entities that can support wireless communication for UEs. A mobile switching center (MSC) 134 may communicate with the RAN 130 and may support voice services, provide routing for circuit-switched calls, and perform mobility management for UEs located within the area served by MSC 134. Optionally, an inter-working function (IWF) 140 may facilitate communication between MME 126 and MSC 134 (e.g., for 1×CSFB).

E-UTRAN 120, serving gateway 124, and MME 126 may be part of an LTE network 102. RAN 130 and MSC 134 may be part of a GSM network 104. For simplicity, FIG. 1 shows only some network entities in the LTE network 102 and the GSM network 104. The LTE and GSM networks may also include other network entities that may support various functions and services.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc. In aspects, UE 110 may be a Dual SIM dual standby (DSDS) UE.

Upon power up, UE 110 may search for wireless networks from which it can receive communication services. If more than one wireless network is detected, then a wireless network with the highest priority may be selected to serve UE 110 and may be referred to as the serving network. UE 110 may perform registration with the serving network, if necessary. UE 110 may then operate in a connected mode to actively communicate with the serving network. Alternatively, UE 110 may operate in an idle mode and camp on the serving network if active communication is not required by UE 110.

UE 110 may be located within the coverage of cells of multiple frequencies and/or multiple RATs while in the idle mode. For LTE, UE 110 may select a frequency and a RAT to camp on based on a priority list. This priority list may include a set of frequencies, a RAT associated with each frequency, and a priority of each frequency. For example, the priority list may include three frequencies X, Y and Z. Frequency X may be used for LTE and may have the highest priority, frequency Y may be used for GSM and may have the lowest priority, and frequency Z may also be used for GSM and may have medium priority. In general, the priority list may include any number of frequencies for any set of RATs and may be specific for the UE location. UE 110 may be configured to prefer LTE, when available, by defining the priority list with LTE frequencies at the highest priority and with frequencies for other RATs at lower priorities, e.g., as given by the example above.

UE 110 may operate in the idle mode as follows. UE 110 may identify all frequencies/RATs on which it is able to find a “suitable” cell in a normal scenario or an “acceptable” cell in an emergency scenario, where “suitable” and “acceptable” are specified in the LTE standards. UE 110 may then camp on the frequency/RAT with the highest priority among all identified frequencies/RATs. UE 110 may remain camped on this frequency/RAT until either (i) the frequency/RAT is no longer available at a predetermined threshold or (ii) another frequency/RAT with a higher priority reaches this threshold. This operating behavior for UE 110 in the idle mode is described in 3GPP TS 36.304, entitled “Evolved Universal Terrestrial Radio Access (E-UTRA); User Equipment (UE) procedures in idle mode,” which is publicly available.

UE 110 may be able to receive packet-switched (PS) data services from LTE network 102 and may camp on the LTE network while in the idle mode. LTE network 102 may have limited or no support for voice-over-Internet protocol (VoIP), which may often be the case for early deployments of LTE networks. Due to the limited VoIP support, UE 110 may be transferred to another wireless network of another RAT for voice calls. This transfer may be referred to as circuit-switched (CS) fallback. UE 110 may be transferred to a RAT that can support voice service such as 1×RTT, WCDMA, GSM, etc. For call origination with CS fallback, UE 110 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

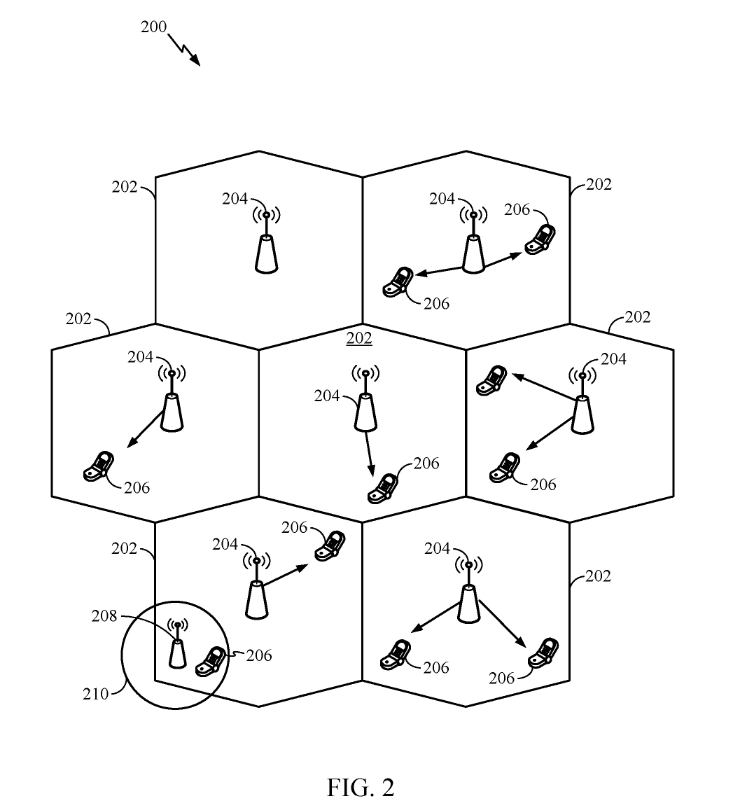

FIG. 2 is a diagram illustrating an example of an access network 200 in an LTE network architecture. UE 206 may transmit an uplink reference signal which may be received by both a serving and non-serving eNB. Serving and non-serving eNBs 204, 208 may receive the uplink reference signal and either of the eNBs may transmit a handover command to the UE based, at least in part, on the uplink reference signal.

In FIG. 2, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 124.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

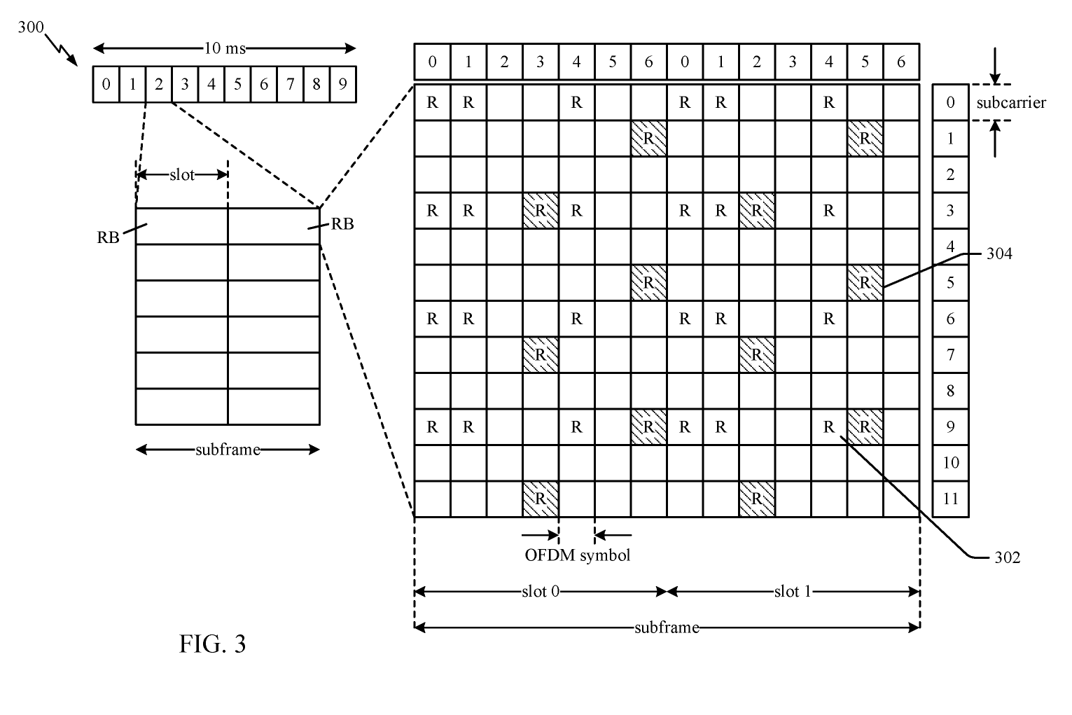

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

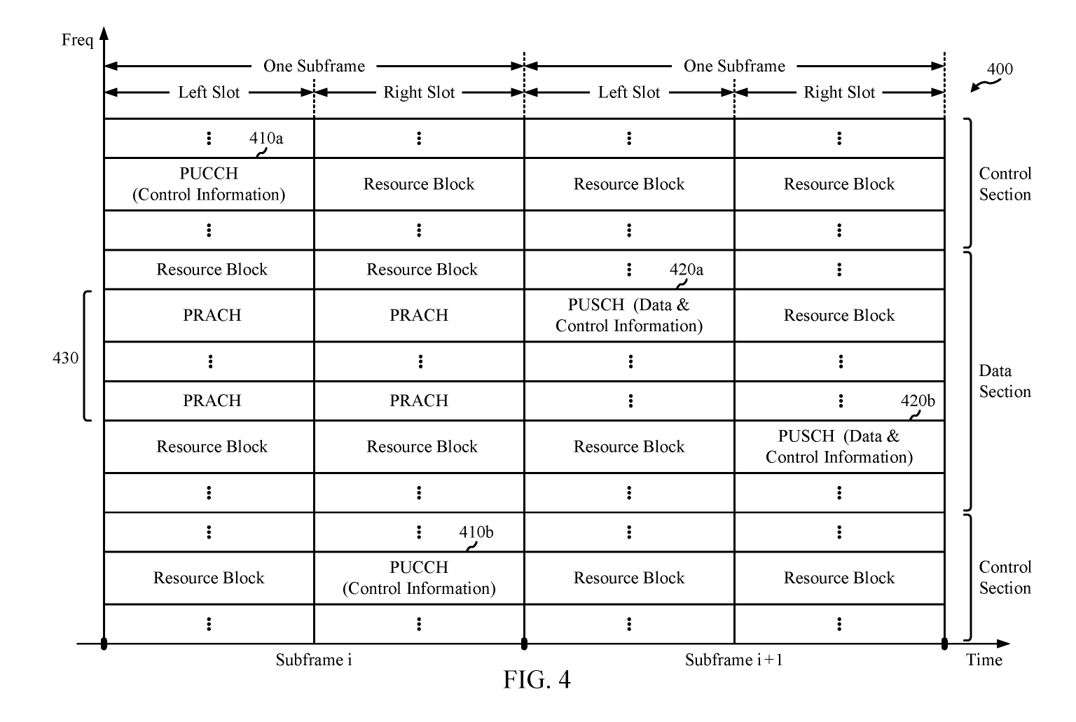

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

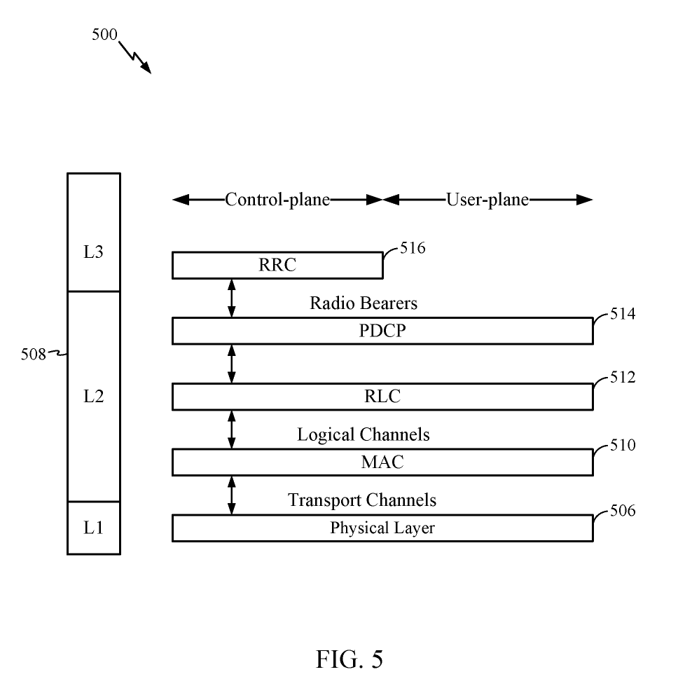

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

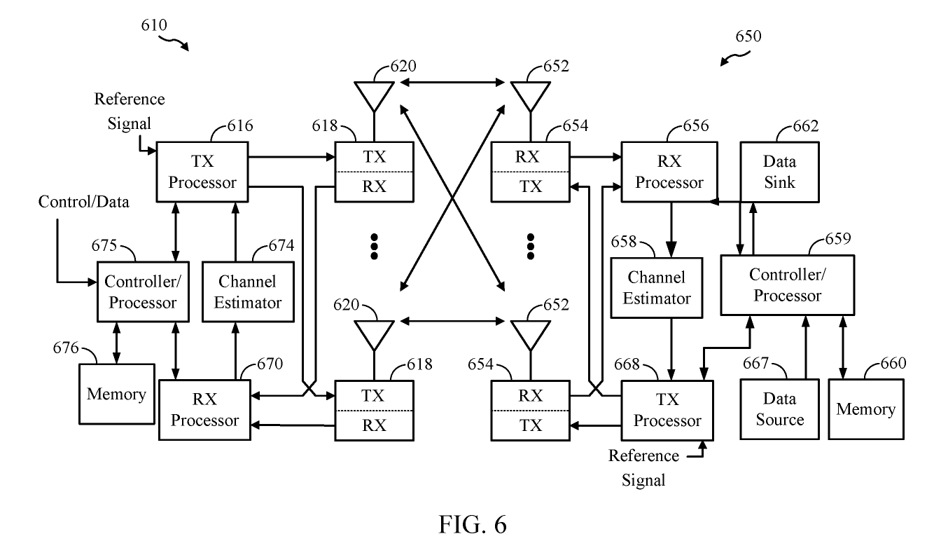

FIG. 6 is a block diagram of an eNB 610 in communication with a UE 650 in an access network in accordance with aspects of the present disclosure. The eNBs of FIG. 1 and FIG. 2 may include one or more components of eNB 610 illustrated in FIG. 6. Similarly, the UEs illustrated in FIGS. 1 and 2 may include one or more components of UE 650 as illustrated in FIG. 6. One or more components of the UE 650 and eNB 610 may be configured to perform the operations described herein.

In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor 659 can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

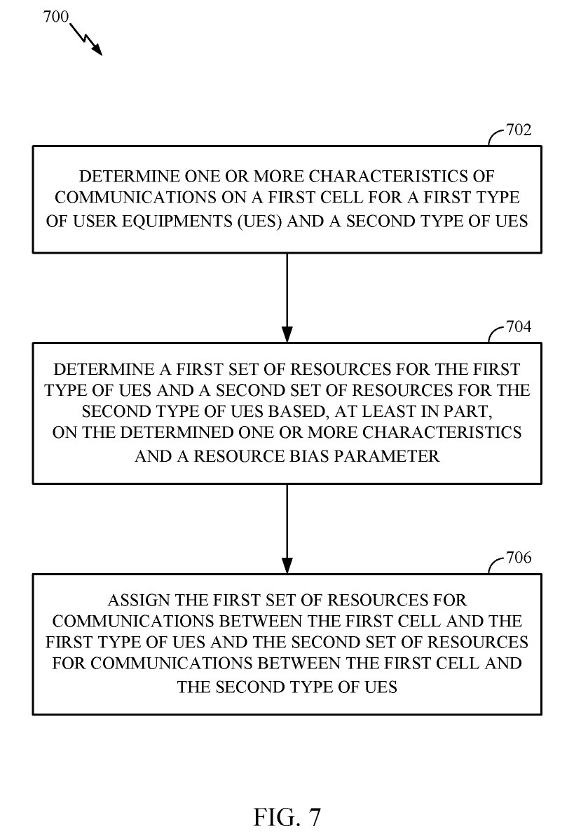

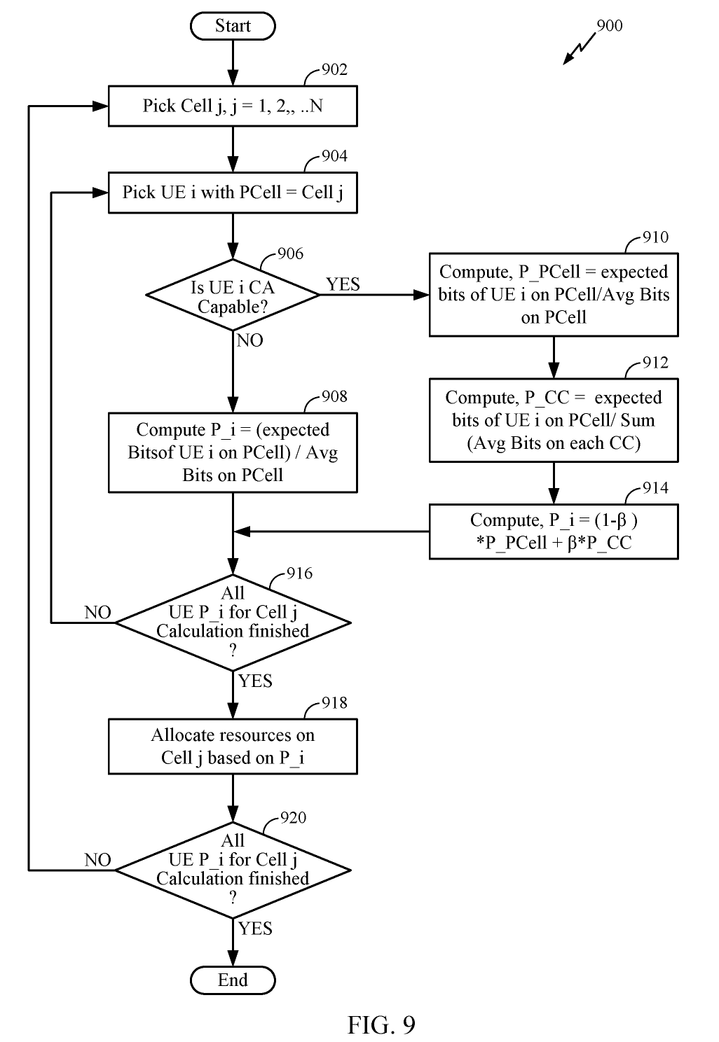

The controller/processor 659 may direct the operation at the UE 650. The controller/processor 659 and/or other processors, components, and/or modules at the UE 650 may perform or direct operations performed by the UE as described herein. The controller/processor 675 may direct the operations at the eNB 610. The controller/processor 675 and/or other processors, components, and/or modules at the eNB 610 may perform or direct operations performed by the eNB as described herein. In aspects, one or more of any of the components shown in FIG. 6 may be employed to perform example operations 700 shown in FIG. 7 and operations 900 shown in FIG. 9, and can also perform other UE and eNB operations for the techniques described herein.

For example, one or more of the antenna 620, transceiver 618, controller/processor, and memory 676 may be configured to receive an uplink reference signal from a UE, measure the uplink reference signal, and transmit a handover command, as described herein. One or more of the antenna 652, transceiver 654, controller/processor 659, and memory 660 may be configured to transmit an uplink reference signal and receive a beamformed downlink signal or handover command, as described herein.

### Example Scheduling Carrier Aggregation (CA)-Capable and Non-CA-Capable User Equipments (UES) Using a Resource Bias Parameter

Carrier aggregation generally allows data rates to scale with an amount of spectrum by allowing CA-capable UEs to communicate using an aggregation of a number of component carriers (e.g., combining up to 5 component carriers for up to 100 MHz of spectrum). In some cases, CA-capable UEs and non-CA-capable UEs may coexist in a wireless cell (e.g., a small cell), and the cell allocates resources to both the CA-capable UEs and non-CA-capable UEs. If a cell scheduler allows CA-capable UEs to maximize their communications capabilities, CA-capable UEs may benefit from increased resource allocation (e.g., a substantial portion up to the entirety of the available system bandwidth); however, by allowing CA-capable UEs to maximize their communications capabilities, limited or no resources may be available for use by non-CA-capable UEs may be impacted. To allow CA-capable UEs to take advantage of the increased data rates enabled by communicating using an aggregation of a number of component carriers while reducing the impact of CA-capable UEs on resource availability for non-CA-capable UEs, a scheduler may be designed to fairly allocate resources between CA-capable UEs and non-CA-capable UEs and within each type of UE.

Various metrics may be used to allocate resources between various users. For example, a cell may use a quality of service (QoS) class identifier priority, a packet delay budget, channel conditions, or other metrics to determine a resource allocation between various UEs in a cell. Regardless of the metrics used to allocate resources, the scheduler may allocate resources to achieve fairness for users with best effort traffic. Fairness may be characterized by a utility function, such as a logarithmic function of an average data rate that achieves a proportionally fair resource allocation between users. For real time traffic, in one example, the utility function may be modeled as an exponential function of the delay experienced by the oldest packet in a packet queue.

A cell may be configured to satisfy a fairness metric within groups of UEs (e.g., CA-capable and non-CA-capable UEs) and across groups of UEs. A scheduler may allocate resources to CA-capable UEs on multiple component carriers and ensure that non-CA-capable UEs operating on a particular component carrier are not highly impacted by the resource allocation for CA-capable UEs on that component carrier (e.g., that the non-CA-capable UEs are allocated insufficient resources to satisfy a quality of service metric).

As discussed herein, a resource bias parameter may be introduced into a scheduling system to favor CA-capable UEs or non-CA-capable UEs. The resource bias parameter may be applied to any type of scheduler, such as a proportionally fair scheduler, used to allocate resources to users in a cell. Different values of the bias factor may affect resource fairness, as discussed in further detail herein. By using a resource bias parameter to influence the allocation of resources between CA-capable UEs and non-CA-capable UEs, certain types of UEs may be favored in resource allocation that other types of UEs, as discussed herein.

In a proportional fair scheduling technique, a scheduler may assign users to each carrier to maximize the sum of the logarithmic transmission rate. In some cases, the proportional fair scheduling technique may assume that the UEs in the cell are CA-capable UEs. Some proportional fair scheduling techniques may attempt to determine a resource allocation for groups of UEs based on types of applications executing on the UEs using a concave logarithmic utility function or a non-concave sigmoidal-like utility function. These scheduling techniques may be used in systems with CA-capable UEs, but also may not consider scheduling for both CA-capable UEs and non-CA-capable UEs.

To allocate resources for a user equipment k, which may be a CA-capable UE or a non-CA-capable UE, a scheduler can identify a resource assignment which maximizes

$${k}^{*} = argmax \frac{{r}_{k} ( t )}{{R}_{k} ( t )} , k = 1 , … , K .$$

rₖ(t) represents the expected bits which will be allocated to the UE k at a given time t, which may depend on the amount of data queued at the UE k and channel conditions. Rₖ(t) represents the average rate of the UE k until time t−1.

The proportional fair metric calculation may differ for CA-capable UEs and non-CA-capable UEs, as CA-capable UEs may be served using multiple component carriers while non-CA-capable UEs may be served using a single component carrier. In some cases, to calculate a proportional fair metric for different types of UEs, the proportional fair metric may be calculated on each component carrier independently for each UE. Calculating the proportional fair metric on each component carrier independently may be unfair for non-CA-capable UEs on a given component carrier, as the total resource allocation across component carriers may not be considered in calculating the proportional fair metric for CA-capable UEs. In another example, a scheduler may consider the total resource allocation across component carriers in the average rate of a CA-capable UE, though the data rate for CA-capable UEs may not be greater than that of non-CA-capable UEs.

To fairly allocate resources to CA-capable UEs and non-CA-capable UEs, a scheduler may use a resource bias parameter β may be used to bias resource allocation towards or against CA-capable UEs (e.g., to give preference in resource allocation to CA-capable UEs or non-CA-capable UEs).

FIG. 7 illustrates example operations that may be performed by a scheduler in a wireless cell to schedule resources for different types of UEs (e.g., CA-capable UEs and non-CA-capable UEs), in accordance with certain aspects of the present disclosure. As illustrated, operations 700 begin at 702, where a scheduler determines one or more characteristics of communications on a first cell for a first type of user equipments (UEs) and a second type of UEs. The characteristics of communications may include, for example, an expected amount of traffic on each of a plurality of component carriers, instantaneous channel conditions for the first and second types of UEs, and so on.

At 704, the scheduler determines a first set of resources for the first type of UEs and a second set of resources for the second type of UEs based, at least in part, on the determined one or more characteristics and a resource bias parameter. The resource bias parameter, as discussed herein, may be an operator-defined value or parameter that indicates whether to give preference in resource allocation to CA-capable UEs or non-CA-capable UEs. At 706, the scheduler assigns the first set of resources for communications between the first cell and the first type of UEs and the second set of resources for communications between the first cell and the second type of UEs

Using the resource bias parameter β, the proportional fair metric for a CA-capable UE may be represented according to the equation:

PF_{CA}=β{ExpectedBitsOnCell_i/ΣBitsServedPerCell}+(1−β){ExpectedBitsOnCell_i/BitsServedInCell_i}

The proportional fair metric for a non-CA-capable UE may be represented according to the equation:

PF_{nonCA}={ExpectedBitsOnCell_i/BitsServedInCell_i}

The expected bits may represent the estimated number of bits to be allocated to the logical channel for a particular UE in a transmission time interval (TTI). In both equations, the expected bits may be calculated as a function of the transport block size (TBS) used for communicating with a given UE, rate requirements (e.g., an aggregate maximum bit rate (AMBR) allowed for best effort traffic), and a queue load for the given UE. The TBS size may be based on a channel quality and resource block limitations for a given UE. In some cases, the expected bits may be represented according to the equation:

ExpectedBitsOnCell_i=min(TBS(MCSOnCell_i,RBLimitPerUE),AMBER/numOfNonGBLRC,queueLoad)

The bits served per cell may represent the average rate of a UE on a given component carrier. For a non-CA-capable UE, bits served in other component carriers other than the primary component carrier used by the non-CA-capable UE is zero.

The resource bias parameter may be used in various resource allocation techniques, including the proportionally fair techniques described above. For example, the resource bias parameter may be used with a max C/I scheduler where scheduling is based, at least in part, on instantaneous channel conditions experienced by each UE. The scheduling metrics calculated in a max C/I scheduler may, for example, consider the expected bits for a given UE and need not consider the average rate for the UEs in a given cell.

In some cases, the resource bias parameter may be dynamically selected based on network conditions. A network operator may, for example, establish a plurality of resource bias parameters corresponding to different scenarios (e.g., ratios of CA-capable UEs to non-CA-capable UEs connected to a cell, expected traffic loading, and so on). In some cases, a scheduler can examine network conditions to select a resource bias parameter to select a resource bias parameter associated with the determined conditions from the plurality of resource bias parameters.

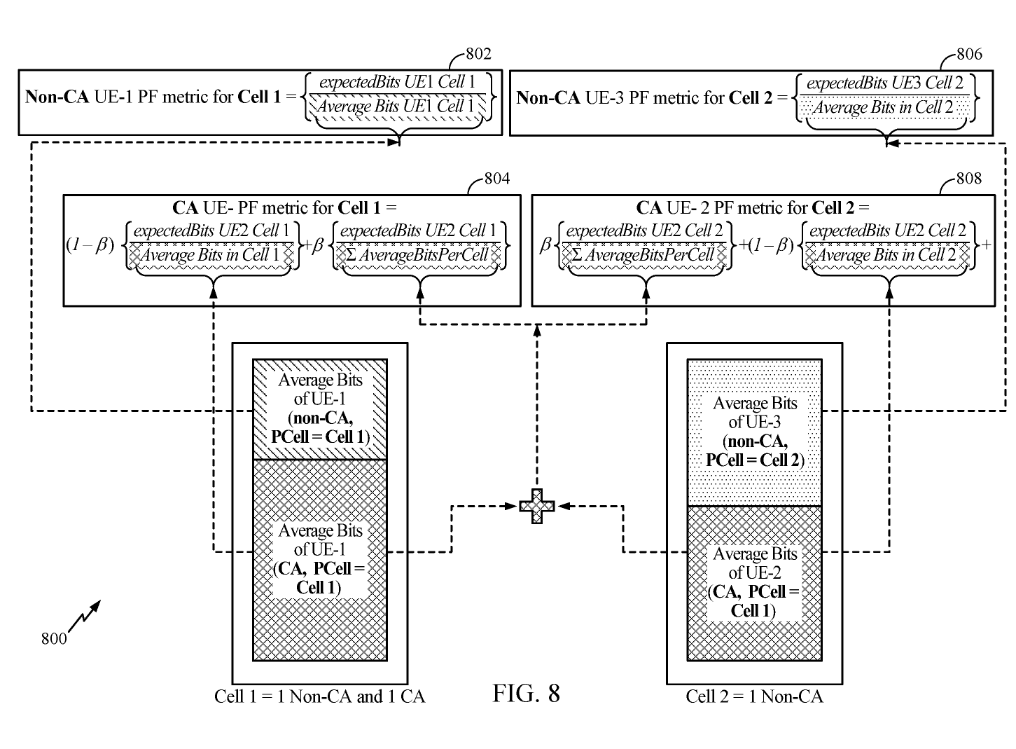

FIG. 8 illustrates an example proportional fair metric computation and resource allocation 800 for a plurality of UEs determined based, at least in part, on a resource bias factor, in accordance with certain aspects of the present disclosure. As illustrated, cell 1 serves a CA-capable UE and a non-CA-capable UE, and cell 2 serves a single non-CA-capable UE. In cell 1, the proportional fair metric 802 for the non-CA-capable UE, UE-1, may be defined as a ratio of the expected number of bits to be allocated to UE-1 to the average number of bits served per UE by cell 1 according to the equation:

$$\{ \frac{ExpectedBits\_UE1 \_Cell1}{AverageBits\_Cell1} \}$$

The proportional fair metric 804 for the CA-capable UE, UE-2, on cell 1 may be defined according to the equation:

$$( 1 - β ) \{ \frac{ExpectedBits\_UE2 \_Cell1}{AverageBits\_Cell1} \} + β \{ \frac{ExpectedBits\_UE2 \_Cell1}{\sum AverageBitsPerCell} \}$$

where ExpectedBits_UE2_Cell1 represents the expected number of bits to be allocated to UE-2 by Cell 1, AverageBits_Cell1 represents the average number of bits served per UE by cell 1, and ΣAverageBitsPerCell represents the total number of bits to be served by the plurality of cells (e.g., as illustrated in FIG. 8, the total number of bits to be served by cell 1 and cell 2)

As illustrated, cell 2 serves a single non-CA-capable UE, UE-3. The proportional fair metric 806 for UE-3 on cell 2 may be defined as a ratio of the expected number of bits to be allocated to UE-3 to the average number of bits served per UE in cell 2. The proportional fair metric 808 for UE-2 (the CA-capable UE in this illustration) on cell 2 may be defined according to the equation:

$$β \{ \frac{ExpectedBits\_UE2 \_Cell2}{\sum AverageBitsPerCell} \} + ( 1 - β ) \{ \frac{ExpectedBits\_UE2 \_Cell2}{AverageBits\_Cell2} \}$$

FIG. 9 illustrates a flow chart of operations 900 for allocating resources to CA-capable UEs and non-CA-capable UEs, in accordance with aspects of the present disclosure. As illustrated, operations 900 start at 902, where a scheduler selects a cell j for analysis. At 904, the scheduler selects a UE i with the selected cell as the primary cell.

At 906, the scheduler determines if the selected UE is a CA-capable UE. If the selected UE is not a CA-capable UE, at 908, the scheduler computes a proportional fair metric for the UE as

$${P}_{i} = \frac{{ExpectedBits\_UE}_{i} {\_Cell}_{j}}{{AverageBits\_Cell}_{j}} .$$

Otherwise, if the selected UE is a CA-capable UE, at 910, the scheduler computes a proportional fair metric for the selected UE and the selected cell. The proportional fair metric for the selected UE and the selected cell may be calculated as

$${P}_{PCell} = \frac{{ExpectedBits\_UE}_{i} {\_Cell}_{j}}{{AverageBits\_Cell}_{j}} .$$

At 912, the scheduler computes a proportional fair metric on a per-component-carrier basis, which may be calculated as

$${P}_{CC} = \frac{{ExpectedBits\_UE}_{i} {\_Cell}_{j}}{\sum AverageBitsPerComponentCarrier} .$$

At 914, the scheduler computes a proportional fair metric for the CA-capable UE. The proportional fair metric for the CA-capable UE may be represented as Pᵢ=(1−β)P_{Pcell}+β(P_{CC}).

At 916, the scheduler determines if a proportional fair metric has been calculated for all UEs in the selected cell. If a proportional fair metric has not been calculated for all UEs in the selected cell, operations 900 return to 904 to calculate a proportional fair metric for another UE in the selected cell. Otherwise, at 918, the scheduler allocates resources on the selected cell based on the calculated proportional fair metrics for each UE (e.g., Pᵢ).

At 920, the scheduler determines if a proportional fair metric has been generated for each cell. If not, operations 900 return to 902, where a scheduler selects a new cell for analysis. Otherwise, operations 900 end.

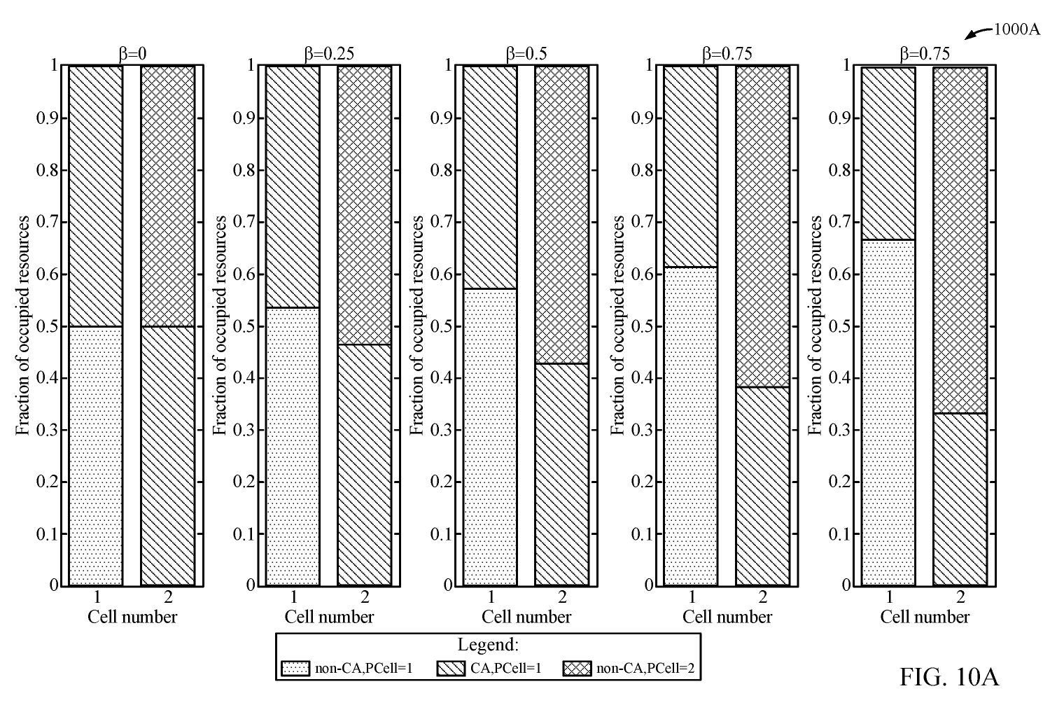

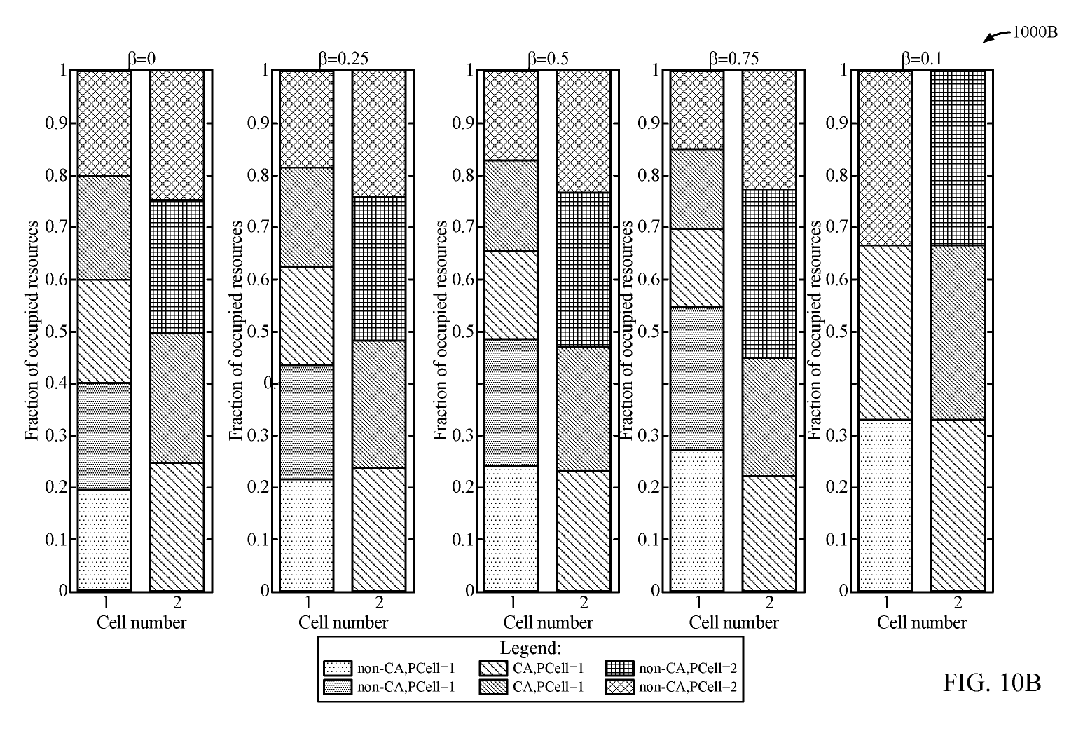

FIGS. 10A and 10B illustrate example resource allocations generated using a resource bias parameter, in accordance with certain aspects of the present disclosure. As illustrated in resource allocation 1000A, a resource allocation is determined for two component carriers, where cell 1 serves one non-CA-capable UE and one CA-capable UE and cell 2 serves one non-CA-capable UE. As illustrated, varying values of the resource bias parameter β may impact the resource allocation for the non-CA-capable UE. A resource bias parameter β value of 0 may correspond to computing a proportional fair metric on each component carrier independently for all UEs, while a resource bias parameter β of 1 may correspond to computing a proportional fair metric across component carriers. As illustrated, different values of the resource bias parameter may be used to ensure that CA-capable UEs benefit from increased resource availability compared to non-CA-capable UEs while providing sufficient resources to the non-CA-capable UEs served on each cell.

In resource allocation 1000B, a resource allocation is determined for two component carriers, where cell 1 serves two non-CA-capable UEs and one CA-capable UE, and where cell 2 serves one non-CA-capable UE and two CA-capable UEs. As illustrated, for a resource bias parameter β value of 1, resources may be allocated equally to CA-capable UEs and non-CA-capable UEs. Other values of the resource bias parameter may be used to adjust the resources assigned to each UE (e.g., when equal resource allocation for each UE may not be feasible).

By introducing a resource bias parameter for scheduling between UEs with best effort traffic and differing carrier aggregation capabilities, a scheduler can allow CA-capable UEs to maximize the use of additional resources across component carriers with little impact to the resource allocation for non-CA-capable UEs capable of operations using a single component carrier. The scheduler may provide resource fairness within groups of UEs and between CA-capable UEs and non-CA-capable UEs. The resource bias parameter may be applied in various scheduling techniques, such as proportionally fair scheduling, max C/I scheduling, and so on.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method for wireless communications, comprising:
determining one or more characteristics of communications on a first cell for a first type of user equipments (UEs) and a second type of UEs;
determining a first set of resources for the first type of UEs and a second set of resources for the second type of UEs based, at least in part, on the determined one or more characteristics and a resource bias parameter; and
assigning the first set of resources for communications between the first cell and the first type of UEs and the second set of resources for communications between the first cell and the second type of UEs.

2. The method of claim 1, wherein the first type of UEs comprise UEs capable of communications using carrier aggregation and the second type of UEs comprise UEs not capable of communications using carrier aggregation.

3. The method of claim 1, wherein the one or more characteristics comprise an expected amount of traffic on at least a first cell for the first type of UEs and the second type of UEs.

4. The method of claim 3, wherein calculating the expected amount of traffic for the first type of UEs comprises calculating an expected amount of traffic on each of a plurality of component carriers.

5. The method of claim 1, wherein the one or more characteristics comprise instantaneous channel conditions for the first type of UEs and the second type of UEs.

6. The method of claim 1, wherein the resource bias parameter comprises a network operator-defined value.

7. The method of claim 1, wherein the resource bias parameter is selected based on a ratio of the first type of UEs and the second type of UEs connected to the first cell.

8. The method of claim 1, further comprising determining one or more characteristics of communications on one or more second cells for the first type of UEs and the second type of UEs, wherein determining the first set of resources for the first type of UEs and the second set of resources for the second type of UEs is further based on the determined one or characteristics of communications on the one or more second cells.

9. An apparatus for wireless communications, comprising:
a processor configured to:
determine one or more characteristics of communications on a first cell for a first type of user equipments (UEs) and a second type of UEs,
determine a first set of resources for the first type of UEs and a second set of resources for the second type of UEs based, at least in part, on the determined one or more characteristics and a resource bias parameter, and
assign the first set of resources for communications between the first cell and the first type of UEs and the second set of resources for communications between the first cell and the second type of UEs; and
a memory coupled to the processor.

10. The apparatus of claim 9, wherein the first type of UEs comprise UEs capable of communications using carrier aggregation and the second type of UEs comprise UEs not capable of communications using carrier aggregation.

11. The apparatus of claim 9, wherein the one or more characteristics comprise an expected amount of traffic on at least a first cell for the first type of UEs and the second type of UEs.

12. The apparatus of claim 11, wherein the processor is configured to calculate the expected amount of traffic for the first type of UEs by calculating an expected amount of traffic on each of a plurality of component carriers.

13. The apparatus of claim 9, wherein the one or more characteristics comprise instantaneous channel conditions for the first type of UEs and the second type of UEs.

14. The apparatus of claim 9, wherein the resource bias parameter comprises a network operator-defined value.

15. The apparatus of claim 9, wherein the processor is configured to select the resource bias parameter based on a ratio of the first type of UEs and the second type of UEs connected to the first cell.

16. The apparatus of claim 9, wherein the processor is further configured to determine one or more characteristics of communications on one or more second cells for the first type of UEs and the second type of UEs, and wherein the processor is configured to determine the first set of resources for the first type of UEs and the second set of resources for the second type of UEs further based on the determined one or characteristics of communications on the one or more second cells.

17. An apparatus for wireless communications, comprising:
means for determining one or more characteristics of communications on a first cell for a first type of user equipments (UEs) and a second type of UEs;
means for determining a first set of resources for the first type of UEs and a second set of resources for the second type of UEs based, at least in part, on the determined one or more characteristics and a resource bias parameter; and
means for assigning the first set of resources for communications between the first cell and the first type of UEs and the second set of resources for communications between the first cell and the second type of UEs.

18. The apparatus of claim 17, wherein the first type of UEs comprise UEs capable of communications using carrier aggregation and the second type of UEs comprise UEs not capable of communications using carrier aggregation.

19. The apparatus of claim 17, wherein the one or more characteristics comprise an expected amount of traffic on at least a first cell for the first type of UEs and the second type of UEs.

20. The apparatus of claim 19, further comprising means for calculating the expected amount of traffic for the first type of UEs, and wherein calculating the expected amount of traffic for the first type of UEs comprises calculating an expected amount of traffic on each of a plurality of component carriers.

21. The apparatus of claim 17, wherein the one or more characteristics comprise instantaneous channel conditions for the first type of UEs and the second type of UEs.

22. The apparatus of claim 17, wherein the resource bias parameter comprises a network operator-defined value.

23. The apparatus of claim 17, further comprising means for selecting the resource bias parameter, wherein the bias parameter is selected based on a ratio of the first type of UEs and the second type of UEs connected to the first cell.

24. The apparatus of claim 17, further comprising means for determining one or more characteristics of communications on one or more second cells for the first type of UEs and the second type of UEs, wherein determining the first set of resources for the first type of UEs and the second set of resources for the second type of UEs is further based on the determined one or characteristics of communications on the one or more second cells.

25. A computer-readable medium having instructions stored thereon which, when executed by a processor, performs an operation, the operation comprising:
determining one or more characteristics of communications on a first cell for a first type of user equipments (UEs) and a second type of UEs;
determining a first set of resources for the first type of UEs and a second set of resources for the second type of UEs based, at least in part, on the determined one or more characteristics and a resource bias parameter; and
assigning the first set of resources for communications between the first cell and the first type of UEs and the second set of resources for communications between the first cell and the second type of UEs.
